(19) United States
(12) Patent Application Publication
(10) Pub. No.: US 2006/0268323 A1
(43) Pub. Date: Nov. 30, 2006

(54) Image processing device using password for job control, and control method thereof

(75) Inventor: Yasuhiro Hashimoto, Osaka-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 11/220,822

(22) Filed: Sep. 8, 2005

(30) Foreign Application Priority Data
May 31, 2005 (JP) 2005-158999

(51) Int. Cl. G06F 3/12

(52) U.S. Cl. 358/1.15; 358/1.13

(57) ABSTRACT

An image processing device is disclosed, in which the data on a job, a password related to the job and the information specifying whether the input of the password is required to control the job are stored. In the image processing device, the information is stored to specify that the input of the password is not required to control a predetermined job in the case where a predetermined condition is met for the predetermined job.

This application is based on Japanese Patent Application No. 2005-158999 filed with the Japan Patent Office on May 31, 2005, the entire content of which is hereby incorporated by reference.

### BACKGROUND OF THE INVENTION

1. Field of the Invention

The present invention relates to an image processing device, or in particular to an image processing device and a control method capable of inputting the information for controlling jobs registered.

2. Description of the Related Art

A technique finds a wide application in which an image processing device such as a printer or MFP (Multi Function Peripherals) is connected to a network to form an image based on the data sent from a plurality of users. In recent years, the increased device versatility, the coloring of the data and the extension of network have increased the number of jobs registered in the image processing device (especially, MFP).

With the increase in the number of jobs registered in the image processing device, the amount of data stored as standby jobs in the device is also on the increase.

Based on the enhanced consciousness of security for information processing, the security functions for job handling in the image processing device have also increased.

As an example of the security functions, the function has spread widely to register a password for each job registered in the device and thus prevent the jobs registered in the device from being controlled by third parties.

The memory capacity incorporated in the device has its own limit. By incorporating the password registration function described above, the job memory amount has increased, thereby sometimes posing the problem that the memory utilization efficiency and performance is deteriorated.

In view of this, various techniques have so far been disclosed for the printer having the job security function.

Japanese Laid-Open Patent Publication No. 08-016331, for example, discloses a technique in which a limited execution time is set for each job and upon lapse of the execution time during the job execution, the job in execution is discarded as a time-out error.

Japanese Laid-Open Patent Publication No. 2001-159963, on the other hand, discloses a technique in which a super user password is defined, and by inputting the super user password, all the jobs registered with a password can be deleted or otherwise processed.

In the technique disclosed by Japanese Laid-Open Patent Publication No. 08-016331, however, a job is deleted by the time-out error regardless of the contents thereof. Depending on the contents of the job deleted, the job deletion exhibits the effect of avoiding the performance reduction of the printer on the one hand and may cause the user to feel inconvenient on the other hand.

With regard to the technique disclosed in Japanese Laid-Open Patent Publication No. 2001-159963, a method has been called for whereby the users other than those informed of the super user password can also perform the operation to avoid the printer performance reduction.

Specifically, a technique has been in demand for the printer having the job security function to avoid the performance reduction in a manner conforming with the status quo of the printer applications.

### SUMMARY OF THE INVENTION

The present invention has been developed in view of this situation, and the object thereof is to avoid the performance reduction of an image processing device having the job security function in a manner desired by the user.

According to one aspect of the present invention, there is provided an image processing device including first to third memory units and an information update unit. The first memory unit stores the data on jobs. The second memory unit stores the passwords related to the data on the jobs stored in the first memory unit. The third memory unit stores the information to specify whether the input of the password stored in the second memory unit is required to control the job of which the data is stored in the first memory unit. The information update unit updates the information stored in the third memory unit. The information update unit also determines whether a predetermined condition has been met for a predetermined job stored in the first memory unit, and upon determination that the condition has been met, causes the third memory unit to store the information specifying that the password input is not required to control the predetermined job.

According to another aspect of the present invention, there is provided an image processing device including first and second memory units, a determining unit and a data processor. The first memory unit stores the data on jobs. The second memory unit stores the information on the characteristics of the jobs of which the data is stored in the first memory unit. The determining unit determines whether a predetermined condition has been met for the jobs stored in the first memory unit. The data processor processes the data stored in the first memory unit. The data processor also deletes the data stored in the first memory unit, for which the predetermined condition is met on the one hand, and transfers the data stored in the first memory unit to a predetermined device, with regard to the jobs of which specified characteristics are stored in the second memory unit on the other hand.

According to the present invention, there is also provided a method of controlling the image processing device, including the steps of storing the data on jobs, storing the passwords related to the data on the jobs stored, storing the information specifying whether the input of the stored password is required or not to control the operation for the jobs of which the data is stored, determining whether a predetermined condition is met or not, and upon determination that the predetermined condition is met, updating the information stored to control a predetermined job to the information specifying that the input of the stored password is not required.

According to the present invention, the requirement to input the password for controlling a job is determined in accordance with whether a predetermined condition is met for the particular job. Specifically, in accordance with the contents of each job and the situation in which the image processing device is used, it is determined whether the input of a password is required to control the job.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of an image processing system including a MFP as an image processing device according to a first embodiment of the present invention.

FIG. 2 is a diagram showing a hardware configuration of the MFP shown in FIG. 1.

FIG. 3 is block diagram showing a hardware configuration of the PC shown in FIG. 1.

FIG. 4 is a diagram showing an example of information on the job attributes stored in the MFP of FIG. 1.

FIG. 5 is a diagram showing an example of the screen displayed on the MFP shown in FIG. 1.

FIG. 6 is a flowchart of the process executed by the CPU of the MFP at the time of switching on power of the MFP of FIG. 1.

FIG. 7 is a diagram showing an example of the login standby screen displayed on the display screen of the MFP in FIG. 1.

FIG. 8 is a diagram showing an example of the login screen on the displayed on the display screen of the MFP in FIG. 1.

FIG. 9 is a flowchart showing the allowable control setting process executed by the CPU of the MFP shown in FIG. 1.

FIG. 10 is a diagram showing an example of the basic screen displayed on the display screen of the MFP constituting the image processing device according to a second embodiment of the present invention.

FIG. 11 is a diagram schematically showing an example of the information stored as the attributes of each job in the MFP constituting the image processing device according to the second embodiment of the present invention.

FIG. 12 is a diagram showing an example of the operating screen displayed in the MFP constituting the image processing device according to the second embodiment of the present invention.

FIG. 13 is a diagram showing another example of the operating screen displayed in the MFP constituting the image processing device according to the second embodiment of the present invention.

FIG. 14 is a flowchart showing the job management process executed by the CPU of the MFP constituting the image processing device according to the second embodiment of the present invention.

FIGS. 15 and 16 are flowcharts showing the subroutine of the job monitor process shown in FIG. 14.

FIG. 17 is a diagram schematically showing another example of the information stored as the attributes of each job in the MFP constituting the image processing device according to the second embodiment of the present invention.

FIG. 18 is a diagram showing an example of the transfer destination display screen displayed on the MFP constituting the image processing device according to the second embodiment of the present invention.

FIG. 19 is a diagram showing another example of the transfer destination display screen displayed on the MFP constituting the image processing device according to the second embodiment of the present invention.

FIGS. 20 and 21 are flowcharts showing the job management process executed by the CPU of the MFP constituting the image processing device according to a third embodiment of the present invention.

### DESCRIPTION OF THE PREFERRED EMBODIMENTS

### First Embodiment

First, the configuration of an image processing system including a MFP as an image processing device according to a first embodiment of the present invention is described.

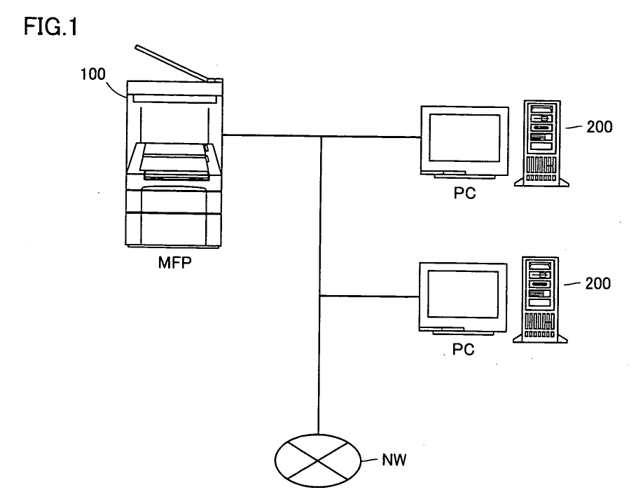

Referring to FIG. 1, the image processing system includes a MFP 100 connected to a network, and a plurality of personal computers (PC) 200 connected to the same network. The network is connected to an internet NW, and therefore MFP 100 and PCs 200 can access an external device through the internet NW. Also, MFP 100 can be connected to a line such as a PSTN (Public Switched Telephone Network) for facsimile transmission, etc. The numbers of the MFPs and the PCs connected to the network are not limited to those shown in FIG. 1.

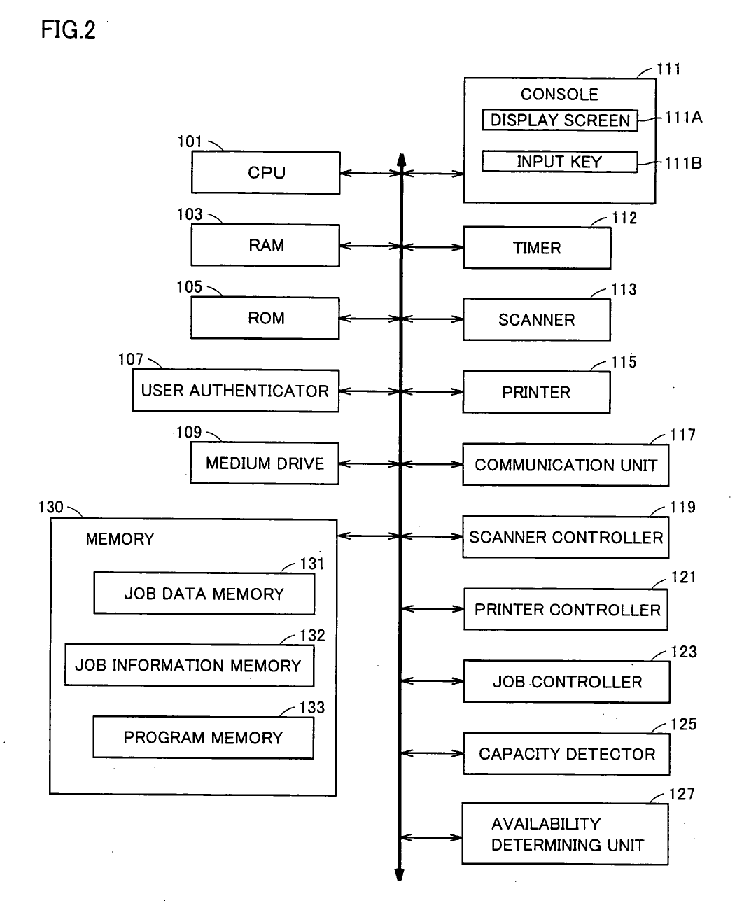

Next, with reference to FIG. 2, the hardware configuration of MFP 100 shown in FIG. 1 is described.

In FIG. 2, MFP 100 includes a CPU 101 for controlling MFP 100 in general, a RAM (Random Access Memory) 103 to store the data temporarily, a ROM (Read Only Memory) 105 to store programs and constants, a user authenticator 107 to store the user ID and the related password of each user and authenticating each user, a medium drive 109 to read and write information from and into a flexible disk or a CD-ROM (Compact Disk Read Only Memory) providing a recording medium removable from MFP 100, a memory unit 130 to store the data of the jobs registered in MFP 100, an operating panel 111 to receive the operation of the user, a timer 112 having the time measuring function, a scanner 113, a printer 115 to print the image data on the paper, a communication unit 117 to connect to the network or the PSTN, a scanner controller 119 to control the operation of the scanner 113, a print controller 121 to control the operation of the printer 115, a job controller 123 to control the execution of the jobs registered in the memory unit 130, a capacity detector 125 to detect the available capacity of the memory unit 130, and an availability determining unit 127 to determine whether each device (scanner 113, printer 115, etc.) in MFP 100 is available for use. The determination as to whether a given device is available for use or not is the determination as to whether the particular device can normally operate or not. In the case where printer 115 has an automatic paper feeder, for example, the determination is whether the automatic paper feeder has not developed any paper jam or an error.

Memory unit 130 includes a job data memory 131 to store the job data, a job information memory 132 to store the job attributes, and a program memory 133 to store the job processing program for processing the job.

Operating panel 111 includes a display screen 111A to display the status of MFP 100 and the command choices to the user, and an input key 111B. Display screen 111A and input key 111B can be configured of a liquid crystal display and a touch panel arranged thereon.

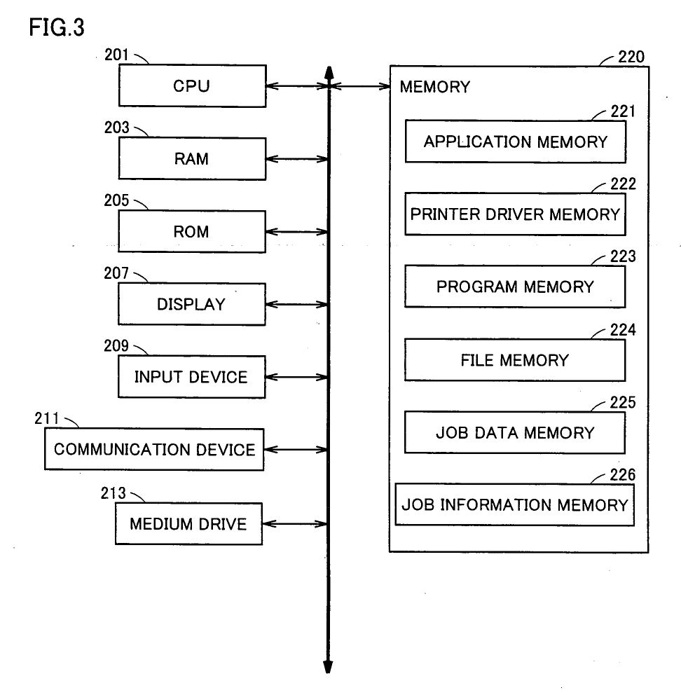

Next, with reference to FIG. 3, the hardware configuration of PC 200 shown in FIG. 1 is described.

Referring to FIG. 3, PC 200 includes a CPU 201 to control the image processing device as a whole, a RAM 203, a ROM 205, a display 207, and an input device 209 having a keyboard and a mouse, a communication unit 211 used for connection to the network or communication with an external device, a medium drive 213 to read or write information from and to a flexible disk or a CD-ROM providing a recording medium removable from PC 200, and a memory unit 220.

Memory unit 220 includes an application memory 221 to store the program data of various applications, a printer driver memory 222 to store the program data of the printer driver to prepare the job data on the job executed by MFP 100, a program memory 223 to store the program to process the job, a file memory 224 to store a file prepared by various applications, a job data memory 225 to store the job data prepared, and a job information memory 226 to store the job attributes.

In the image processing system according to this embodiment, a job can be registered in MFP 100 either by operating MFP 100 or by transmitting the job data and job information prepared in PC 200 to MFP 100 through the network.

With regard to the jobs registered in MFP 100, the job data are stored in job data memory unit 131, and the job information in job information memory 132.

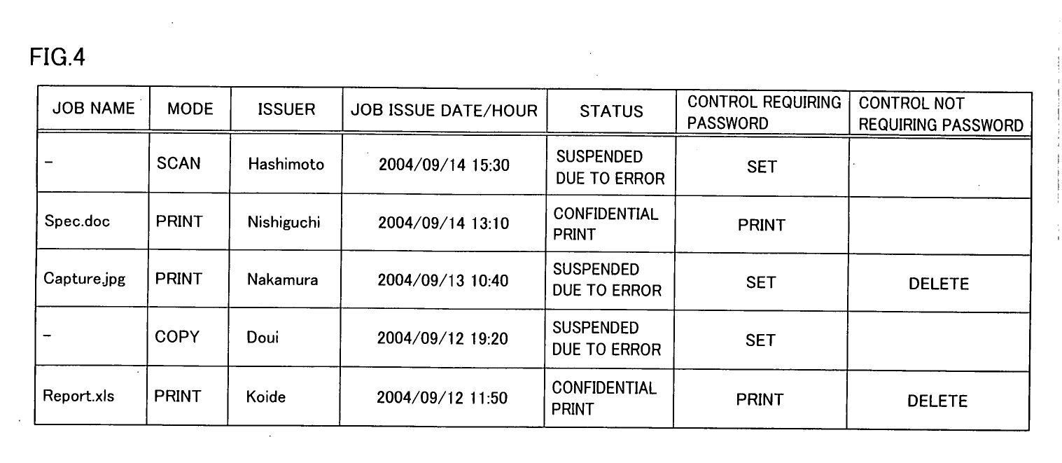

Also, in MFP 100 according to this embodiment, the information shown in FIG. 4 is stored in job information memory unit 132 for each job registered in the particular device as a job attribute.

In FIG. 4, MFP 100 has stored therein the name of each job (the file name of the file to be processed, for example), the operation mode, the job issuer, the date/hour the job is issued (registered in MFP 100), the status of the particular job, the type of control of the job requiring the password input (operation requiring the password) and the type of control of the job requiring no password input (operation requiring no password). The password herein corresponds to the user ID of the person (issuer) who has registered the job.

The mode is defined as the operation of various types such as scanning, printing, copying, facsimile transmission/receiving and the facsimile transmission executed by MFP 100. The scanning is the operation of the scanner 113 to generate an image data by performing the scanning operation on an original set in MFP 100. The printing is the operation of printer 115 to print out a file transmitted from PC 200. The copying is the operation to generate the image data by scanner 113 performing the scanning operation on the original set in MFP 100 and print out the image data through printer 115. The facsimile transmission/receiving is the operation in which the data received through the PSTN is printed out on printer 115. The facsimile transmission is the operation in which the file transmitted from PC 200 or the image data generated by scanner 113 is transmitted to an external device through the PSTN.

Also, the issuer is defined as a user ID of the user who has registered a job.

The job status “confidential print” is defined as the status waiting for the input of the password for printout in the print job. The confidential print is defined, apart from the job registration, as the requirement that the job printout is conditional on the input of the password of the issuer.

The job control includes the setting, printing and deletion. The control for setting is the setting or change of the contents of the operation for executing the job, which includes, for example, the change of the setting of the resolution or the file format for the job in scan mode. The control for printing, on the other hand, includes the setting and change of the designation of the number of prints or the two-side print paper for the job in print mode. The control for deletion includes the deletion of the corresponding job data and job information from memory unit 130.

In MFP 100, the display as shown in FIG. 5 is made on display screen 111A based on the information on each job as shown in FIG. 4.

On the screen shown in FIG. 5, the information shown in FIG. 4 is displayed for each job. On the screen shown in FIG. 5, the contents of the control stored as the control requiring the password and the control requiring no password (FIG. 4) are displayed collectively as the “control”. Specifically, as shown in FIG. 5, the name of the control stored as the control requiring a password is underlined and displayed in the “control” column, while the name of the control stored as the control requiring no password is displayed without any underline.

As described above, MFP 100 has the job registered or can execute the job registered on its own operation or by the data transmission from PC 200. The job registration is specifically defined as the storage of the data on the job (job data and job information) in memory unit 130.

As described above with reference to FIG. 4, etc., the operation of MFP 100 includes those requiring the password of the job issuer and those not requiring it.

In MFP 100, in accordance with the job characteristics or the situation of MFP 100, the type of the operation requiring the password for each job is changed and the information shown in FIG. 4 is updated accordingly.

The specific operation of MFP 100 including the change of the type of control requiring the password is described below.

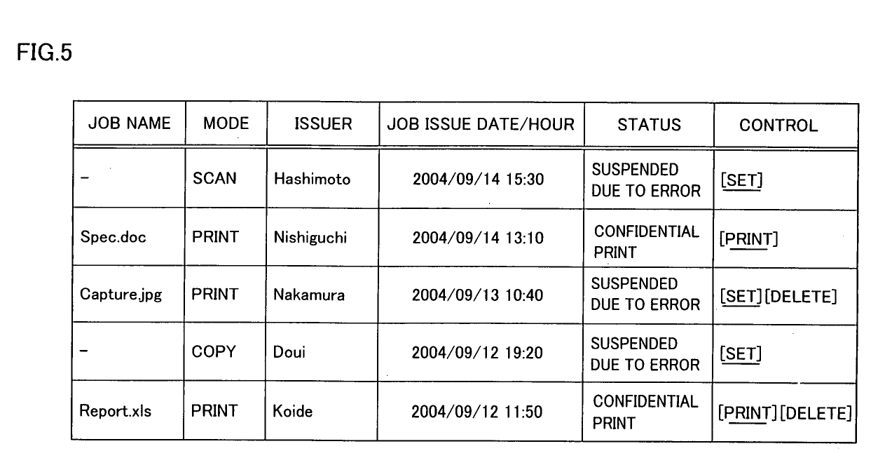

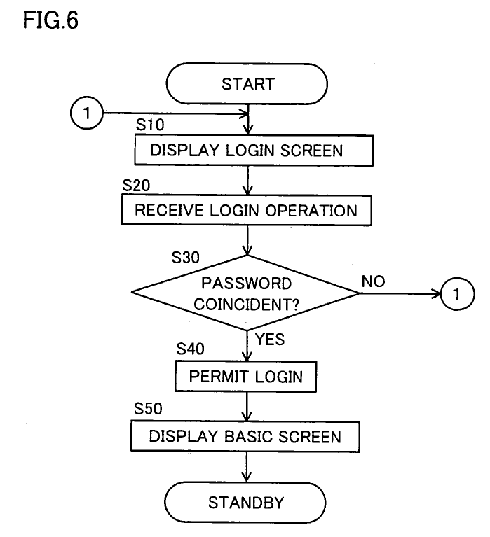

FIG. 6 is a flowchart showing the process executed by CPU 101 when power of MFP 100 is switched on.

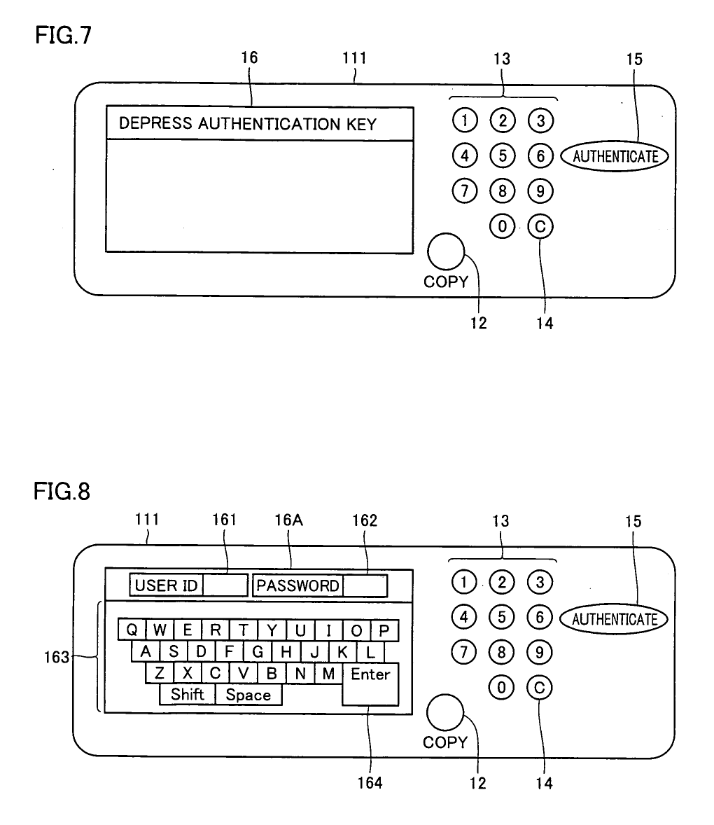

In FIG. 6, CPU 101 displays the login screen on the display screen 111A of operating panel 111 in step S10. FIG. 7 shows an example of the login standby screen.

In FIG. 7, login standby screen 16 is displayed on the display screen (display screen 111A) of the operating panel 111. Operating panel 111 includes a copy key 12 to execute the copy operation, a numeral key 13 to input a numeral, a clear key 14 to clear the contents of the input, and an authentication key 15 to execute the login operation.

Next, CPU 101 receives the login operation from the user in step S20. The login operation is to depress authentication key 15 first of all. Upon depression of authentication key 15, CPU 101 displays the login screen on display screen 111A. An example of the login screen is shown in FIG. 8.

Referring to FIG. 8, login screen 16A is displayed on the display screen (display screen 111A) of operating panel 111. Input columns 161, 162 to input the user ID and the password are displayed on login screen 16A. Further, a keyboard 163 to input the alphabets in input columns 161, 162 and an enter key 164 operated upon complete input of the user ID or the password are displayed on input columns 161, 162.

The login operation includes the input of the user ID and password in input columns 161, 162 and the depression of enter key 164.

Upon receipt of the login operation in step S20, CPU 101 determines whether the password input in step S30 coincides with the one stored as related to the input user ID. Upon determination that they coincide with each other, the process proceeds to step S40. Upon determination that they fail to coincide with each other, on the other hand, the message “the password is different” is displayed on display screen 111A, and the process returns to step S10.

In step S40, CPU 110 executes the process for permitting the user to log in the user ID input to input column 161. As a result, the user of the user ID received in step S20 has successfully logged in to MFP 100. The user that has logged in is hereinafter called the login user.

Next, in step S50, CPU 101 displays the basic screen on display screen 111A and enters the standby mode waiting for the operation from the user. On the basic screen, the information on the job registered in MFP 100 may be displayed as shown in FIG. 5.

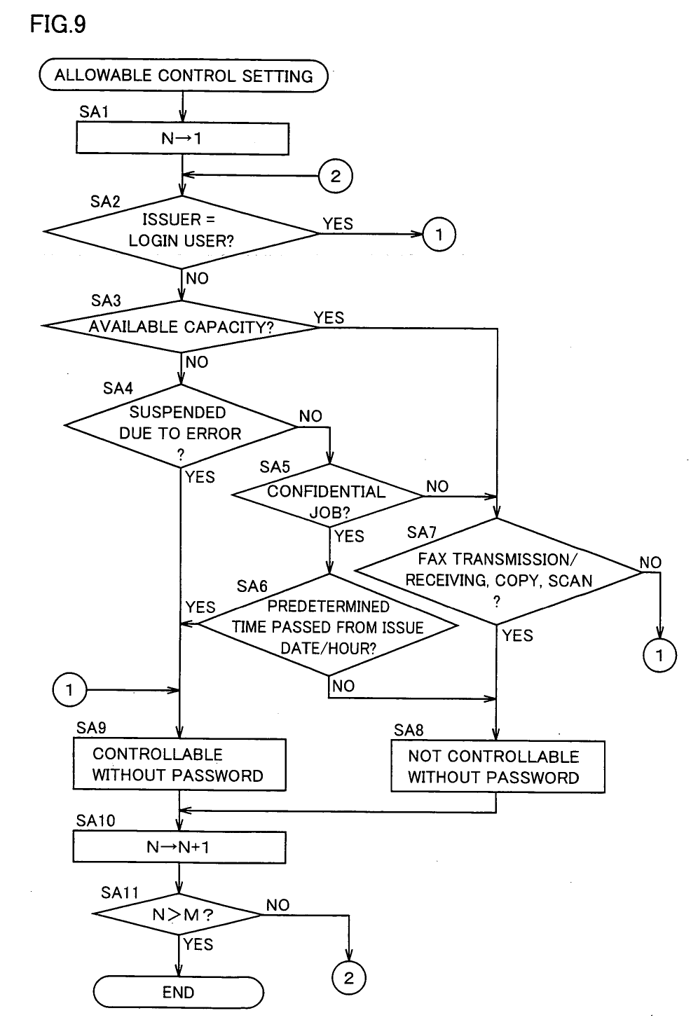

After MFP 100 enters the standby mode, CPU 101 executes the process for changing the type of operation requiring the password (the allowable control setting process) for each job as shown in FIG. 4. With reference to the flowchart of FIG. 9 showing this process, this process is described below.

In the allowable operation setting process, CPU 101 first sets a variable N used in this process to 1 in step SA1 and the process proceeds to step SA2.

In step SA2, CPU 101 determines whether the issuer is the same as the present login user for the Nth job registered. Upon determination that the issuer is the same as the present login user, the process proceeds to step SA9. Otherwise, the process proceeds to step SA3.

In step SA3, CPU 101 causes capacity detector 125 to detect the available capacity of job data memory unit 131 of the memory unit 130, and determines whether the particular available capacity is more than a predetermined capacity corresponding to one job, i.e. whether data memory unit 131 has an available capacity corresponding to one more job. Upon determination that such a capacity is available, the process proceeds to step SA7. Otherwise, the process proceeds to step SA4.

In step SA4, CPU 101, based on the determination of availability determining unit 127, determines whether the device requiring the Nth registered job in MFP 100 is suspended in operation due to an error. The device requiring the job is scanner 113 and printer 115 in the case where the job is in copy mode, scanner 113 in the case where the job is in scan mode and printer 115 in the case where the job is in print mode. Upon determination that the operation is suspended due to an error, the process proceeds to step SA9, and otherwise to step SA5.

In step SA5, CPU 101 determines whether the Nth job registered is a confidential job or not. The confidential job is defined as a registered job executed on condition that a password is input such as a confidential print. Since the job is executed on condition that the password is input, the confidential job is considered a job in which the timing of executing the job coincides with the timing of inputting the password by the issuer. CPU 101, upon determination that a job is confidential, proceeds to step SA6, and otherwise to step SA7.

In step SA6, CPU 101 determines whether the present time has passed a predetermined time length from the date/hour (date/hour issued) at which the Nth job is registered. Upon determination that the present time has so passed, the process proceeds to step SA8, and otherwise to step SA9.

As step SA7, CPU 101 determines whether the Nth job registered is which one of the facsimile transmission/receiving, copying and scanning, and upon determination that the registered job is one of them, the process proceeds to step SA9, and otherwise to step SA8.

In step SA8, CPU 101 determines that there is no control requiring the password, i.e. the control is prohibited unless the password is input for all the types of control for the Nth job registered, and the process proceeds to step SA10.

In step SA9, on the other hand, CPU 101 determines that the control of deletion and transfer for the Nth job registered is possible without inputting the password, and the process proceeds to step SA10. By the process of step SA9, the table shown in FIG. 4 is updated in such a manner that the “deletion” and the “transfer” are registered in the column of the control requiring no password for the Nth job registered. The control for transfer is defined as a control to transfer the job data to the job issuer. In MFP 100, for example, the mail address of the user on the network as related to the user ID is stored in the user authenticator 107, and upon execution of the control for transfer, the job data is transmitted to the mail address of the job issuer. After the job data is transferred, the job data, the job information and job attributes for the particular job are desirably deleted.

In step SA10, CPU 101 updates by incrementing variable N by 1, and the process proceeds to step SA11.

In step SA11, CPU 101 determines whether variable N has exceeded the total number M of jobs currently registered in MFP 100, and upon determination that variable N has not yet exceeded M, returns the process o step SA2. Upon determination that N has exceeded M, on the other hand, the process is ended.

In MFP 100 described above in this embodiment, with regard to the jobs registered and issued by the login user, the login user can perform the operation to delete and transfer the particular jobs.

In the case where the available capacity of memory unit 131 is not sufficient to register one job and a registered job is suspended due to a device error, the login user, even though not the issuer of the job, can delete or transfer the job without inputting the corresponding password.

Also, in the case where the capacity is not available and a job registered in MFP 100 is a confidential one which has passed a predetermined period of time (predetermined time) from registration, then the login user, even though not the issuer of the particular job, can delete or transfer the job. As a result, in the case where the user who has registered the confidential job forgets the registration and the confidential job remains not executed and the data of the confidential job remains in memory unit 131 for a protracted length of time, then the login user can delete and transfer the confidential job without inputting the password associated with the confidential job. As an alternative, only one of the jobs that have passed a predetermined period of time from registration, such as the oldest registered job, can be deleted or transferred without inputting the password.

Even in the case where the capacity is available, the login user other than the issuer can delete and transfer a registered job without inputting the corresponding password, if the registered job is in other than facsimile transmission/receiving mode, copy mode and scan mode. In the case where the capacity is available, on the other hand, the job in facsimile transmission/receiving mode, copy mode or scan mode cannot be deleted or transferred unless the corresponding password is input by the login user other than the issuer. With regard to the job in facsimile transmission/receiving mode, the original providing the base of the job is held by the facsimile sender and not existent in situ (for example, in the neighborhood of the image processing device). Also, with regard to the job in copy mode or the job that can be scanned and transmitted by facsimile, the original providing the base of the job may have been disposed of and may no longer exist. In the case where a job is deleted against the will of the issuer, therefore, the job is considered difficult to register again.

The allowable control setting process described above is executed at predetermined time intervals. In this embodiment, the “predetermined period of time”, the “predetermined time intervals” and the “capacity corresponding to one job” in the allowable control setting process are determined arbitrarily in accordance with the environment in which the image processing system is installed.

The allowable control setting process described above is executed after the user logs in to MFP 100. The login operation to MFP 100 is carried out by direct operation of operating panel 111 of MFP 100 or by the operation of input device 209 of PC 200 connected to the network. In the case where a predetermined operation is performed on input device 209, CPU 101 causes display 207 to display a screen corresponding to the login standby screen or the login screen and receives the login operation from PC 200 thereby to permit the user of PC 200 to log in. In the case where the user from PC 200 logs in to MFP 100, the basic screen is displayed not on display screen 111A of MFP 100 but on display 207 of PC 200.

### Second Embodiment

An image processing system including an image processing device according to a second embodiment of the present invention has a hardware configuration similar to that of the image processing system according to the first embodiment shown in FIG. 1.

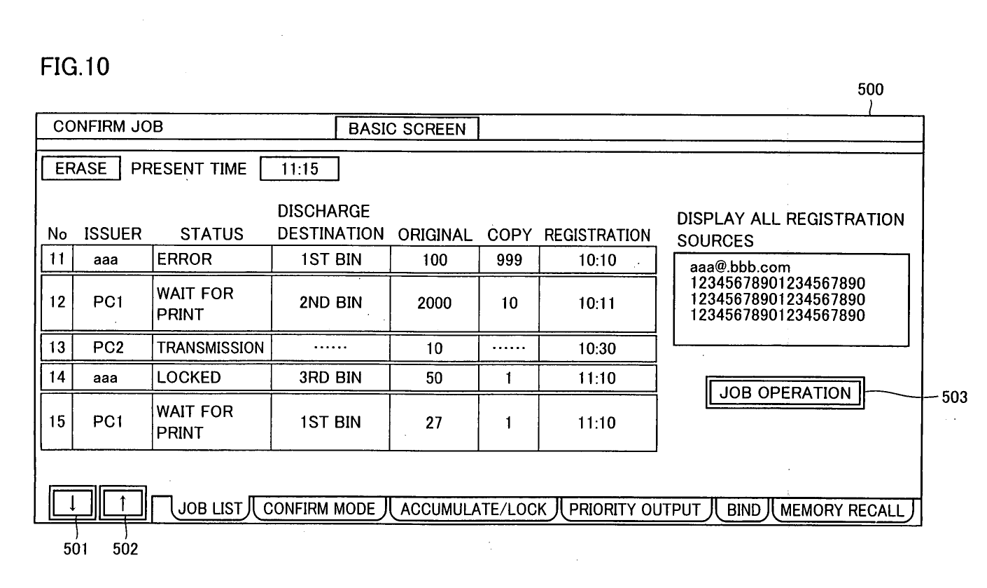

A list of jobs registered in the image processing device, together with the numbers (Nos.) attached thereto, are displayed on basic screen 500 displayed on the display screen of the image processing device according to this embodiment shown in FIG. 10. The image processing device according to the present invention includes a plurality of bins for outputting the paper, and the bins of the destination of the paper output by the job are displayed as a discharge destination on basic screen 500. Also, the time when each job is registered is displayed on basic screen 500.

Further, any of the jobs on display can be selected on basic screen 500, so that an upper key 501 and a lower key 502 for changing the job selected and a job operating key 503 for determining a selected job are also displayed. In the image processing device according to this embodiment, a job is selected by upper key 501 and lower key 502 from the jobs displayed in the list, and job operating key 503 is operated to select one of the jobs registered.

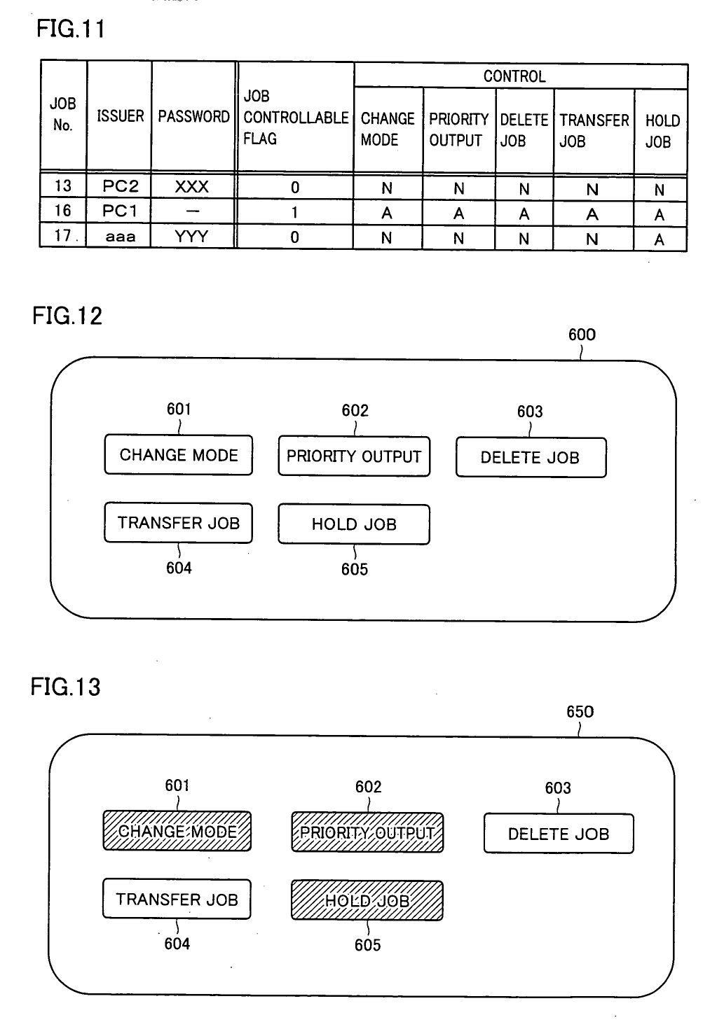

In the image processing device according to this embodiment, the information shown in FIG. 11 are stored as attributes of each job.

Referring to FIG. 11, the image processing device has stored therein the number, the issuer, the password of the issuer, the status of the job controllable flag (1 or 0) and the status indicating whether the password is required for the login user to perform various control operations. The password of the issuer is stored only in the case where the job is registered with a password. This password is not necessarily preset such as the one corresponding to the user ID of the issuer, but may be set for each job at the time of registration by the user who has registered the job. The control operation according to this embodiment includes the change of the job mode, the setting to give priority to the job output, the job deletion, the job transfer and the holding of job execution. In FIG. 11, “A” is indicated in the case where the control is permitted without inputting the password, and “N” is indicated in the case where the operation is not permitted unless the password is input. This information corresponds to the information to specify whether the password input is required or not. The job controllable flag is the one used for the job management process described later.

In the MFP according to this embodiment, once the user selects a job as described with reference to FIG. 10, the screen (operating screen) for performing the operation on the selected job is displayed as shown in FIG. 12.

In FIG. 12, an operating screen 600 has displayed thereon a mode change key 601 for changing the job mode, a priority output key 602 for outputting the job in priority, a job deletion key 603 for deleting the job, a job transfer key 604 for transferring the job to PC 200, etc., and a job hold key 605 for holding the job execution.

On the operating screen, the key corresponding to the control permitted without inputting any password and the key corresponding to the control not permitted without inputting a password are displayed to the login user in different forms. In the case where the job deletion and transfer are permitted without a password while the mode change, the priority output and the holding are not permitted without any password, for example, as shown in operating screen 650 of FIG. 13, job deletion key 603 and job transfer key 604 are displayed similarly to those in FIG. 12, while mode change key 601, priority output key 602 and job hold key 605 are displayed in reverse video. The display in reverse video is indicative that each key corresponds to a prohibited control.

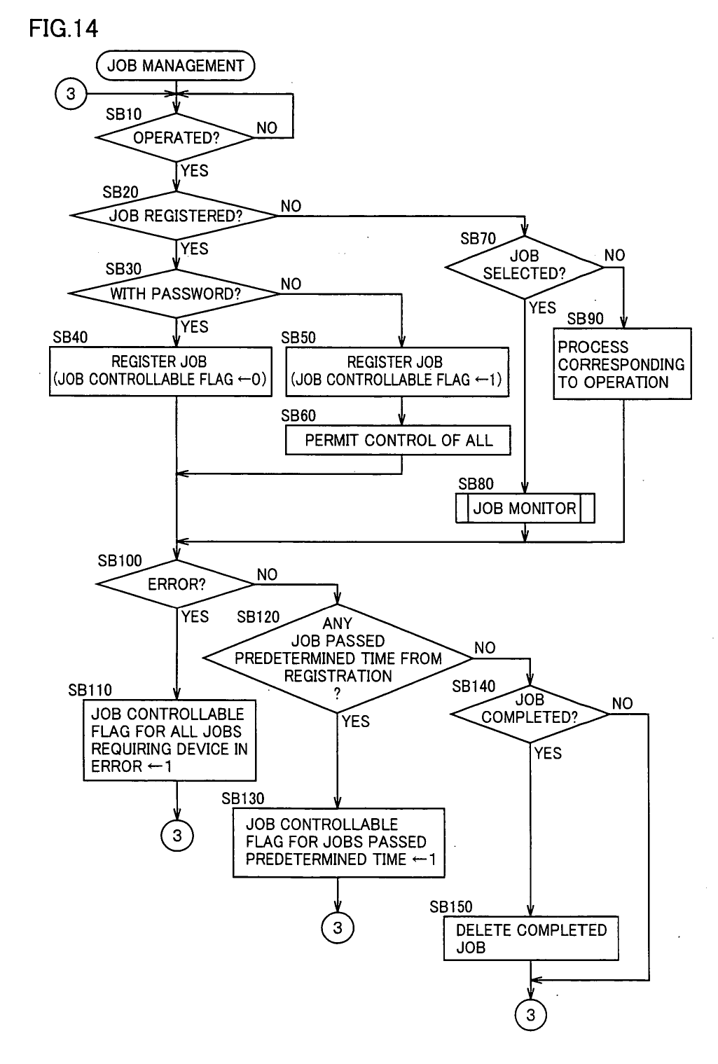

Also in this embodiment, like in the first embodiment, whether the control on the job is permitted or not without inputting a password is determined after the user logs in to MFP for each content of the control. The process (job management process) executed by the CPU of the MFP according to this embodiment to determine whether the control for the job is permitted or not without password input is described below with reference to the flowchart of FIG. 14.

Referring to FIG. 14, the CPU of the MFP according to this embodiment (hereinafter referred to as CPU 101) detects in step SB10 whether the operation has been conducted on the operating panel of the MFP in the job management process. Upon determination that such an operation is conducted, the process proceeds to step SB20.

In step SB20, CPU 101 determines whether the operation conducted is the one for registering the job, and upon determination that the operation is so conducted, the process proceeds to step SB30. Otherwise, the process proceeds to step SB70.

In step SB30, CPU 101 determines whether the user has conducted the operation for registering the job with a password, and upon determination that the user has so conducted the operation, the process proceeds to step SB40. Otherwise, i.e. in the case the determination is that the registration operation is conducted without attaching a password, the process proceeds to step SB50.

In step SB40, CPU 101 executes the process to register a job by appropriately storing the job data and the job information in memory unit 130. In this case, CPU 101 also generates the attribute information as shown in FIG. 11 for a newly registered job. In step SB40, CPU 101 sets the job controllable flag to zero for the newly registered job. Also, with regard to the newly registered job, the password of the current login user (or the password set at the time of registration) is also stored as the attribute information shown in FIG. 11. After the process of step SB40, CPU 101 proceeds to step SB100.

In step SB50, CPU 101 executes the process of registering a job as in step SB40. In step SB50, however, CPU 101 sets the job controllable flag to 1 for generating the attribute of the newly registered job. After the process of step SB50, CPU 101 proceeds to step SB60.

In step SB60, CPU 101 stores all the five contents of the control operations shown in FIG. 11 for the job newly registered in step SB50 to give permission without password input, and the process proceeds to step SB100.

In step SB70, CPU 101 determines whether the detection in step SB10 is the operation to select one of the jobs registered in MFP. Upon determination that the operation is such, CPU 101 proceeds to step SB80. Upon determination otherwise, on the other hand, CPU 101 executes the process corresponding to the contents of operation in step SB90 and proceeds to step SB100.

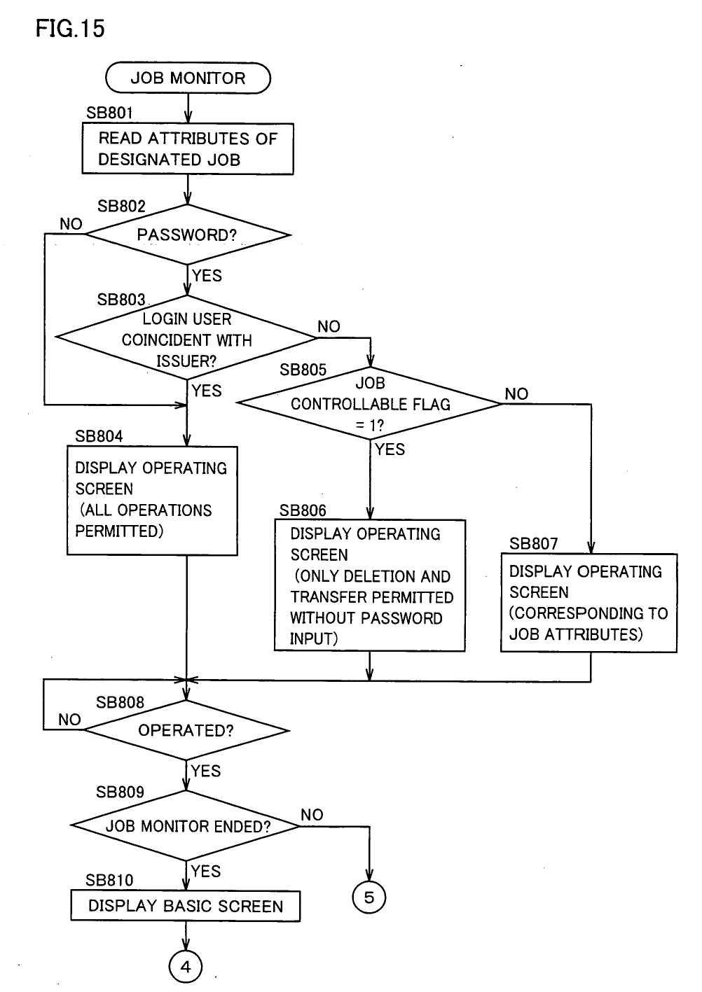

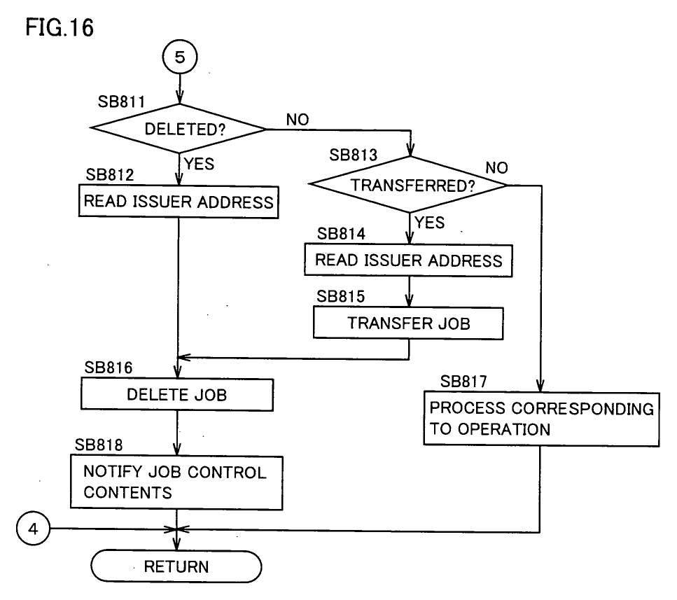

In step SB80, CPU 101 monitors the job and proceeds to step SB100. The contents of the job monitor process are described with reference to FIGS. 15 and 16 showing the flowcharts of the subroutine of the particular process.

In FIG. 15, the job monitor process is executed by CPU 101 first reading the attribute of the designated job in the attribute information shown in FIG. 11 in step SB801. The designated job is defined as a job selected upon determination of CPU 101 that the operation in step SB70 is to select one job.

Next, CPU 101 determines in step SB802 whether the password is stored as an attribute of the designated job, and when so determined, proceeds to step SB803. Otherwise, the process proceeds to step SB804.

In step SB803, the issuer is extracted from the attributes of the designated job, and it is determined whether the issuer coincides with the login user or not. Upon determination that the issuer coincides with the login user, the process proceeds to step SB804. Otherwise, the process proceeds to step SB805.

In step SB804, CPU 101 displays the operating screen for the designated job on the display screen of the MFP, and proceeds to step SB808. The operating screen displayed in this case is the one to permit all the operations without password input as shown in FIG. 12.

In step SB805, CPU 101 determines whether the job controllable flag for the designated job is set at 1 or not, and when so determined, proceeds to step SB806. Otherwise, the process proceeds to step SB807.

In step SB806, CPU 101 displays the operating screen for the designated job on the MFP display screen, and proceeds to step SB808. The operating screen displayed in this case is the one as shown in FIG. 13 in which only the control for job deletion and transfer is permitted without password input.

In step SB807, CPU 101 displays the operating screen for the designated job on the MFP display screen, and proceeds to step SB808. The operating screen displayed in this case has the key display format determined in accordance with the contents stored as the attribute as shown in FIG. 11.

In step SB808, CPU 101 determines whether the user has performed the operation, and when so determined, proceeds to step SB809. In step SB808, in the case where the key is operated for the control not permitted without password input, CPU 101 requests the user to input the password. In the case where an appropriate password is input, the process proceeds to step SB809, while in the absence of appropriate password input, the process stands by in step SB808 without proceeding to step SB809. Specifically, in the case where mode change key 601, priority output key 602 or job hold key 605 is operated on the operating screen 650 shown in FIG. 13, CPU 101 proceeds to step SB809 on condition that the password corresponding to the job to be processed as of the particular time point is input.

In step SB809, CPU 101 determines whether the operation detected in step SB808 is to end the display of the operating screen. When so determined, the display of the operating screen is ended on the display screen of the operating panel in step SB810, and the basic screen is displayed, followed by returning the process. In the case where it is determined that the operation detected in step SB808 is not to end the display of the operating screen, on the other hand, CPU 101 proceeds to step SB811.

Referring to FIG. 16, CPU 101 determines in step SB811 whether the detecting operation in step SB808 is the one for job deletion key 603, and when so determined, proceeds to step SB812. Otherwise, the process proceeds to step SB813.

In step SB812, CPU 101 reads the address of the issuer of the designated job on the network and proceeds to step SB816. According to this embodiment, the MFP has stored therein the address of each user on the network in addition to the user ID and the password. In step SB812, CPU 101 reads the user ID of the issuer of the designated job from the attributes shown in FIG. 11, and reads the address on the network corresponding to the user ID.

In step SB813, CPU 101 determines whether the operation detected in step SB808 is the one for job transfer key 604, and when so determined, proceeds to step SB814. Otherwise, the process proceeds to step SB817.

In step SB817, CPU 101 executes the process corresponding to the operation performed, and returns the process to step SB80 (FIG. 14).

In step SB814, CPU 101, as in step SB812, reads the address of the job issuer on the network, and proceeds to step SB815.

In step SB815, CPU 1101 transmits (transfers) the job data to the address read in step SB814, and the process proceeds to step SB816.

In step SB816, CPU 101 deletes the designated job, and the process proceeds to step SB818. The job deletion is defined as the deletion of the information on the particular job for the attributes shown in FIG. 11 as well as the job data and the job information.

In step SB818, CPU 101 notifies the contents of the control operation executed for the job (the contents of steps SB812, SB816 or steps SB814 to 816) by mail to the address read in step SB812 or SB814, and causes the process to return to step SB80 (FIG. 14). In this case, the contents of the operation may be notified together with the reason for the operation. As the reason for the operation, in the case where the job controllable flag for the job is set to 1 by the process of step SB110 described later, for example, CPU 101 notifies a “device error”, and in the case where the job controllable flag is set to 1 by the process of step SB130 described later, notifies a “time out”.

Referring again to FIG. 14, in step SB100, CPU 101 determines whether the device of MFP has developed an error, and upon determination that an error has occurred, proceeds to step SB110, otherwise to step SB120.

In step SB110, CPU 101 sets the job controllable flag to 1 for the job requiring the device determined to have developed an error in step SB100 in the job attributes shown in FIG. 11, and returns the process to step SB10. The device requiring the job is, for example, scanner 113 and printer 115 in the case where the job is in copy mode, scanner 113 in the case where the job is in scan mode, and printer 115 in the case where the job is in print mode.

In step SB120, by referring to the time at which each job is registered, CPU 101 determines whether there is any job that has passed a predetermined time without being executed from the time point of registration, and when so determined, proceeds to step SB130, and when determined otherwise, to step SB140.

In step SB130, CPU 101 sets the job controllable flag to 1 for the attribute of the job shown in FIG. 11 which has passed a predetermined time without being executed, and then the process returns to step SB10.

In step SB140, CPU 101 determines whether the job in execution is completed in the MFP, and when so determined, deletes the completed job in step SB150, while at the same time returning the process to step SB10. In the case where no completed job is detected in step SB140, on the other hand, CPU 101 returns the process directly to step SB10.

According to the embodiment described above, the job controllable flag is set to 1 for the job that has developed an error of the required device and the job which is left without being executed for at least a predetermined time from registration (steps SB110, SB130). As a result, with regard to these jobs, the deletion and transfer to the login user other than the issuer is permitted without inputting the password corresponding to the job (steps SB805, SB806).

In such a case as this, the attributes of the job shown in FIG. 11 are also changed. Specifically, with regard to the attributes shown in FIG. 11, assume that jobs of numbers 13 and 17 have developed an error in the device required or the jobs are left without being executed for a predetermined time after registration. As shown in FIG. 17, the attributes are updated in such a manner that the operation of job deletion and job transfer for each case is permitted without password input (changed from N to A, for example).

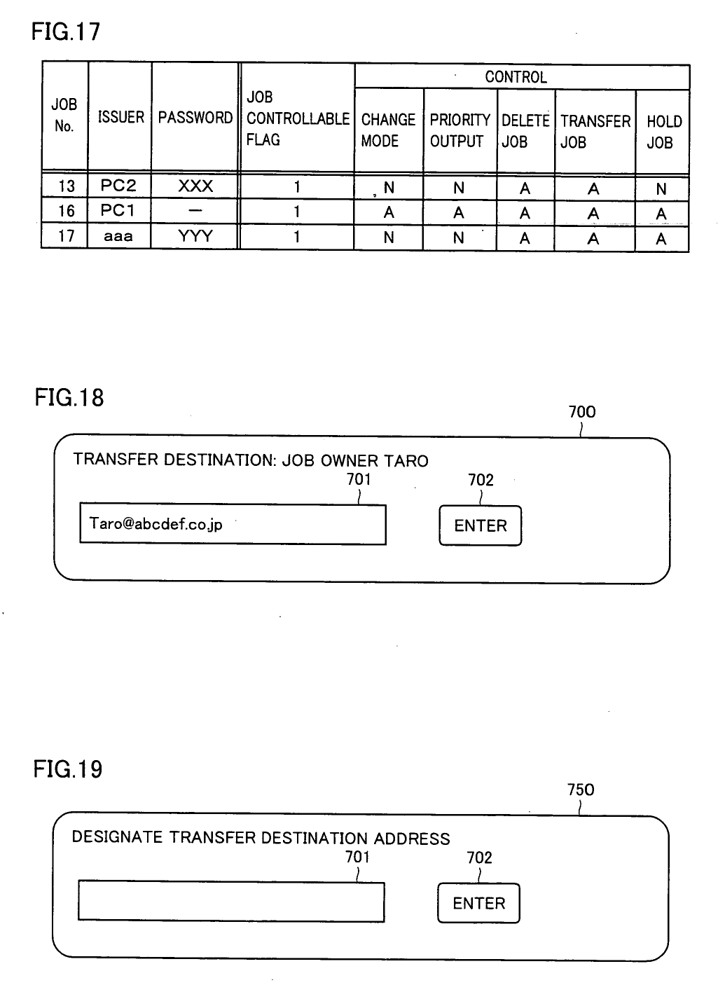

In the case where the job is transferred in step SB815, the transfer destination display screen is displayed on the display screen of the operating panel. An example of the transfer destination display screen is shown in FIG. 18. Referring to FIG. 18, an address display column 701 for displaying the address of the transfer destination and an enter key 702 for giving an instruction to execute the transfer are displayed on the transfer destination display screen 700. Basically, the job is transferred to the issuer of the particular job. Thus, the user ID (Taro) of the job issuer is displayed on the transfer destination display screen, and the address of the job issuer is displayed on the address display column 701.

In the case where the issuer and the login user are identical with each other, for example, the job transfer destination may determined freely by the login user. In such a case, the transfer destination display screen 750 as shown in FIG. 19 is displayed on the display screen during the process of step SB815. On the transfer destination display screen 750, the address display column 701 is vacant into which the user can input an arbitrary address.

### Third Embodiment

The image processing system according to the third embodiment of the present invention may have the same hardware configuration as the image processing system according to the second embodiment described above.

In the image processing system according to this embodiment, the job management process executed by the CPU of the MFP is partly different from the job management process executed by the CPU of the MFP according to the second embodiment. The difference of the job management process executed by the CPU of the MFP according to this embodiment from that of the second embodiment is mainly described below.

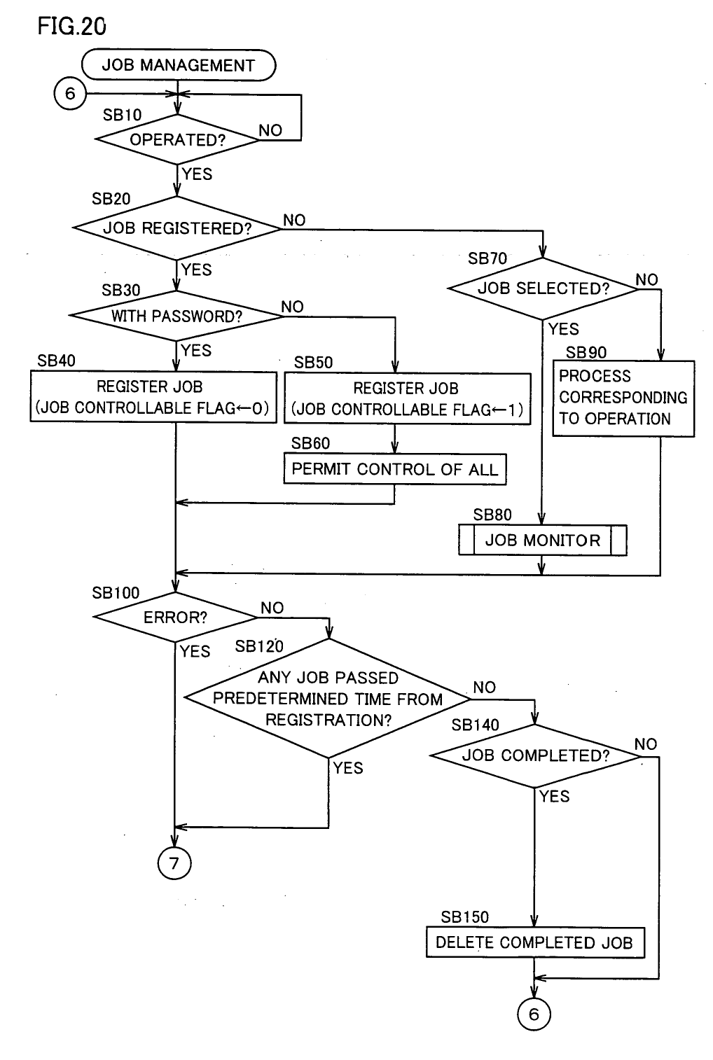

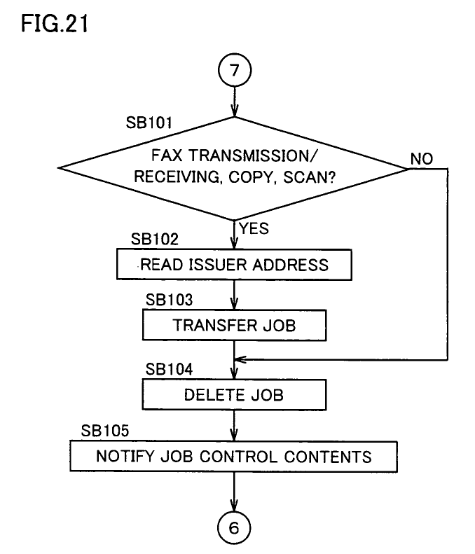

FIGS. 20 and 21 are flowcharts of the job management process executed by the CPU of the MFP according to this embodiment.

Referring to FIG. 20, the process similar to the process corresponding to the job management process according to the second embodiment is executed in steps SB10 to SB90 by the CPU (hereinafter referred to as CPU 101) of the MFP according to this embodiment.

In step SB100, CPU 101 determines whether an error has developed in the device of the MFP, and when determined so, the process proceeds to step SB101. Otherwise, the process proceeds to step SB120.

In step SB120, CPU 101 determines, by referring to the time when each job is registered, whether there is any job that has passed a predetermined time without being executed from the registration time point. Upon determination that such a job exists, the process proceeds to step SB101, and otherwise to step SB140.

In step SB140, CPU 101 determines whether the job in execution is completed at a particular time point in the MFP, and upon determination that the job is so completed, deletes the completed job in step SB150 and returns to step SB10. In the case where the job completion is not detected in step SB140, on the other hand, CPU 101 returns the process to step SB10.

Referring to FIG. 21, in step SB101, CPU 101 reads the mode for the job requiring the device of which it is determined that an error has occurred in step SB100 or the job determined to have passed a predetermined time without being executed from the registration time in step SB120, and determines whether the particular mode is the facsimile transmission/receiving, copying or scanning. In the case where CPU 101 determines that the job mode is one of them, the process proceeds to step SB102. In the case where the job mode is none of them, the process proceeds to step SB104.

In step SB102, CPU 101 reads the address of the issuer of the job requiring the device of which it is determined that an error has developed in step SB100 or the address of the issuer of the job determined to have passed a predetermined time without being executed from the time of registration in step SB120.

Next, in step SB103, CPU 101 executes the process whereby the job requiring the device of which it is determined that an error has occurred in step SB100 or the job determined to have passed a predetermined time without being executed from the time point of registration in step SB120 is transferred to the address read in step SB102. Then, the process proceeds to step SB104.

In step SB104, CPU 101 executes the process of deleting the job requiring the device of which it is determined an error has developed in step SB100 or the job determined to have passed a predetermined time without being executed from the time point of registration in step SB120. In step SB105, the contents of the operation executed on the job in steps SB102 to SB104 are notified by mail, etc. to the job issuer, and then the process is returned to step SB10.

In this embodiment described above, the job that has developed an error in the required device and the job left without being executed for a predetermined time are automatically deleted. The job to be deleted, if in facsimile transmission/receiving mode, copy mode or scan mode, is deleted after being transferred to the issuer. According to this embodiment, the job is transferred to the issuer thereof (the area where the data providing the address of the job issuer is stored in the memory unit having a device connected to the network, such as the mail box of the issuer of the job defined on the network). The present invention is not limited to such a case, however, and the transfer destination may be a server, if any, on the network. In this case, CPU 101 desirably notifies the issuer to which the job is transferred of the fact that the transfer has been made and the transfer destination.

Three embodiments of the present invention are described above. In each of the embodiments, the password constituting the condition for permitting the operation for each job is the same as the password of the job issuer used for login operation. The present invention is not limited to such a case, however, and the password may be stored as job information for each job at the time of registration thereof.

According to the present invention described above, the situation is avoided in which the requirement or no requirement of the password for job control is determined regardless of the contents of the job. Specifically, the situation in which the job is deleted by time-out regardless of the contents of the job is avoided. Also, in the absence of a special user such as informed of the super password, the job considered not required can be deleted. According to the present invention, therefore, the performance of the image processing device having the job security function in the manner desired by the user can be prevented from being reduced.

Also, according to the present invention, the advisability of deleting the data on the job stored in the first memory unit and the advisability of transferring the data to a predetermined device are determined in accordance with whether a predetermined condition is met for job or not.

Further, according to the present invention, in the case where an error occurs in the device for executing a registered job, the job is deleted, and further, the data on the job is transferred to a predetermined device as required.

As a result, the job deletion can prevent the reduction in the performance of the image processing device. Further, the job deletion can prevent the situation in which the user feels inconvenient. Thus, according to the present invention, the reduction of the performance of the image processing device having the job security function can be prevented in the manner desired by the user.

Since certain changes may be made in the above device and system without departing from the scope of the present invention herein involved, it is intended that all matter contained in the above description or shown in the accompanying drawings shall be interrupted as illustrative and not in a limiting sense.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing device comprising:
a first memory unit to store data on a job
a second memory unit to store a password related to the data on the job stored in said first memory unit;
a third memory unit to store the information specifying whether the password stored in said second memory unit is required to be input to control the job of which the data is stored in said first memory unit; and
an information update unit to update the information stored in said third memory unit, wherein
said information update unit determines whether a predetermined condition is met for a predetermined job stored in said first memory unit, and upon determination that the predetermined condition is met, the information specifying that said password is not required to be input to control said predetermined job is stored in said third memory unit.

2. The image processing device according to claim 1, further comprising:
a capacity detector to detect the available capacity of said first memory unit, wherein
said information update unit determines that said predetermined condition is met in the case where said capacity detector determines that the available capacity of said first memory unit is less than a predetermined capacity.

3. The image processing device according to claim 1, further comprising:
a device to execute a job and an availability determining unit to determine whether said device can be used, wherein
said information update unit determines that said predetermined condition is met in the case where said availability determining unit determines that said device cannot be used.

4. The image processing device according to claim 1, further comprising:
a timer to determine the time length from the time point when the data on the job is stored in said first memory unit, wherein
said information update unit determines that said predetermined condition is met in the case where the time determined by said timer is not less than a predetermined time length.

5. The image processing device according to claim 1, wherein
said information update unit, upon determination that a predetermined condition is met for said predetermined job, stores in said third memory unit the information specifying that the input of said password is not required for the control to delete or transfer the data on said predetermined job.

6. The image processing device according to claim 5, wherein
said third memory unit further stores therein the information specifying a person that has stored the data on a job in said first memory unit,
the device further comprising a notification unit for notifying the person who has stored the data on said predetermined job in said first memory unit in the case where the data on said predetermined job is deleted or transferred.

7. The image processing device according to claim 6, wherein
said notification unit further notifies the person who has stored the data on said predetermined job in said first memory unit the fact that said predetermined condition is met as the reason for deletion or transfer.

8. The image processing device according to claim 1, wherein
said third memory unit stores therein the information specifying whether the input of a password is required to control a plurality of items on the job of which the data is stored in said first memory unit,
the device further comprising a display unit for displaying the data corresponding to said information stored in said third memory unit for each of said plurality of the items.

9. An image processing device comprising:
a first memory unit to store the data on a job;
a second memory unit to store the information on the characteristics of the job of which the data is stored in said first memory unit;
a determining unit to determine whether a predetermined condition is met for the job stored in said first memory unit; and
a data processor to process the data stored in said first memory unit, wherein
said data processor deletes the data stored in said first memory unit with regard to the job for which said predetermined condition is met, and transfers the data stored in said first memory unit to a predetermined device with regard to the job for which said predetermined condition is met and of which the characteristic stored in said second memory unit is a specified characteristic.

10. The image processing device according to claim 9, wherein
said determining unit determines that said predetermined condition is met in the case where a predetermined time length has passed from the time point when the data on the job is stored in said first memory unit.

11. The image processing device according to claim 9, further comprising:
a device to execute the job of which the data is stored in said first memory unit, wherein
said determining unit determines whether said device is available for use,
said data processor deletes the data stored in said first memory unit with regard to the job executed by the device which said determining unit determines is not available for use, and
said data processor transfers the data stored in said first memory unit to said predetermined device with regard to the job which is executed by the device which said determining unit determines is not available for use and of which the characteristic stored in said second memory unit is identical with said specified characteristic.

12. The image processing device according to claim 9, wherein
said predetermined device is a memory device which contains an area for storing the data transmitted to the address corresponding to the user who has stored the data on said job in said first memory unit and which is included in a device communicable with said image processing device.

13. The image processing device according to claim 12, further comprising:
a display unit to display the information specifying the user who has stored the data on said job in said first memory unit.

14. The image processing device according to claim 9, wherein
said specified characteristic is a facsimile receiving job.

15. A method of controlling an image processing device, comprising the steps of:
storing the data on a job;
storing a password related to the data on said job stored;
storing the information specifying whether the input of said stored password is required or not to control the job of which said data is stored;
determining whether a predetermined condition is met; and
updating, upon determination that said predetermined condition is met, said stored information for the control of the predetermined job to the information specifying that the input of the said stored password is not required.

16. The method of controlling an image processing device according to claim 15, wherein
said update step includes the step of updating said stored information for the control to delete or transfer the data on said predetermined job.

17. The method of controlling an image processing device according to claim 16, further comprising the steps of:
storing the information specifying a person who has stored the data on said job; and
notifying the person who has stored the data on said predetermined job in the case where the data on said predetermined job is deleted or transferred.

18. The method of controlling an image processing device according to claim 15, wherein
the step of storing the information specifying whether the input of said password stored is required further includes the steps of:
storing the information for the control of each of a plurality of items for the job; and
displaying the data corresponding to said stored information for each of said plurality of the items.
